(19) United States
(12) Patent Application Publication
(10) Pub. No.: US 2006/0089024 A1
(43) Pub. Date: Apr. 27, 2006

(54) Spark plug connector

(76) Inventors: Markus Kraus, Wiesing (AT); Arno Gschirr, Innsbruck (AT); Markus Kroll, Ginzling (AT)

Correspondence Address: Lorusso & Loud, Suite 312, 15 Rye Street, Portsmouth, NH, 03801, US

(21) Appl. No.: 11/224,656

(22) Filed: Sep. 11, 2005

(30) Foreign Application Priority Data
Oct. 22, 2004 (AT) A 1786/2004

(51) Int. Cl. H01R 13/44; H01R 13/52

(52) U.S. Cl. 439/125; 439/271

(57) ABSTRACT

A spark plug connector (2), in particular for large engines, with an inductive interference suppression device (3) which has a ferromagnetic core (14) with at least one winding (13), preferably a coil, and an ohmic d.c. resistance of at least 20 Ω at 20° C.

The present invention relates to a spark plug connector, in particular for large engines such as large gas engines.

Spark plug connectors form a substantially rigid connection between spark plugs, which primarily in the case of large engines are recessed deep into bores in the engine block, and the spark plug leads which lead to at least one ignition coil. They may attain a length of more than half a metre. Their rigidity is selected such that on the one hand it is readily possible to push them onto the spark plug, preferably without the need for further tools, although on the other hand the spark plug connectors typically have a certain residual flexibility. Thus, in most cases they are not completely rigid.

It is furthermore known from the prior art that ohmic resistor elements can be used to suppress interference in ignition systems. The disadvantage of these interference suppression resistors is that they consume an unnecessarily high quantity of useful energy in order to damp the radio frequency disturbance. This lost energy must on the one hand be made available by the ignition system and on the other hand results in the components concerned, such as the spark plug connector, becoming hot. This heating is highly problematic since, as a result of the electrical insulation resistance demanded among other things of the spark plug connector, materials which may also be poor heat conductors are used. This problem becomes particularly acute if—as is conventional with large engines—ignition systems which generate very high levels of ignition power are employed.

The object of the invention is to provide a spark plug connector which helps to eliminate the problems described.

In accordance with the invention, this is achieved with a spark plug connector, in particular for large engines, with an inductive interference suppression device which has a ferromagnetic core with at least one winding, preferably a coil, and an ohmic d.c. resistance of at least 20 Ω at 20° C.

The use of an inductive interference suppression device according to the invention, instead of the sole use of an ohmic d.c. resistor, significantly improves the energy balance, since the interference suppression device can be configured such that it presents a high resistance to high frequencies and, at the same time, a very low resistance to the lower-frequency useful energy. To achieve optimum interference suppression behaviour, the inductance of the winding or coil is used in conjunction with the ohmic d.c. resistor. To achieve sufficient inductance, a winding with a ferromagnetic core must be used. So that the overall shape can be kept as small as possible, the winding or coil may have a resistor wire to provide the ohmic d.c. resistance. A preferred embodiment provides for the ferromagnetic core to be made from a material which is not electrically conductive, or has very high resistance. An electrically non-conductive ferrite core and a specific d.c. resistance for the interference suppression device of at least 100 Ω, preferably at least 500 Ω, at 20° C., are particularly advantageous.

Further details and advantages of the present invention will emerge from the description below of the drawings, in which:

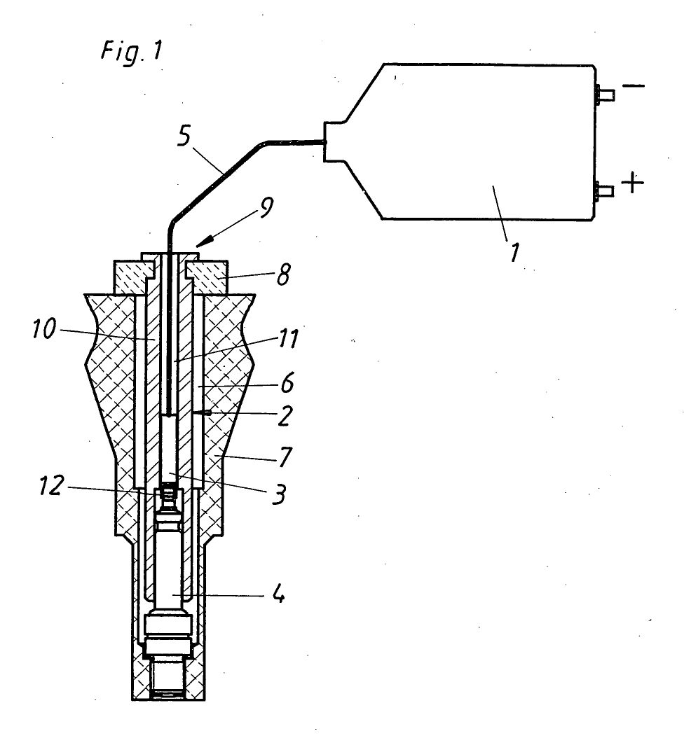

FIG. 1 shows an example embodiment, in accordance with the invention, of a spark plug connector,

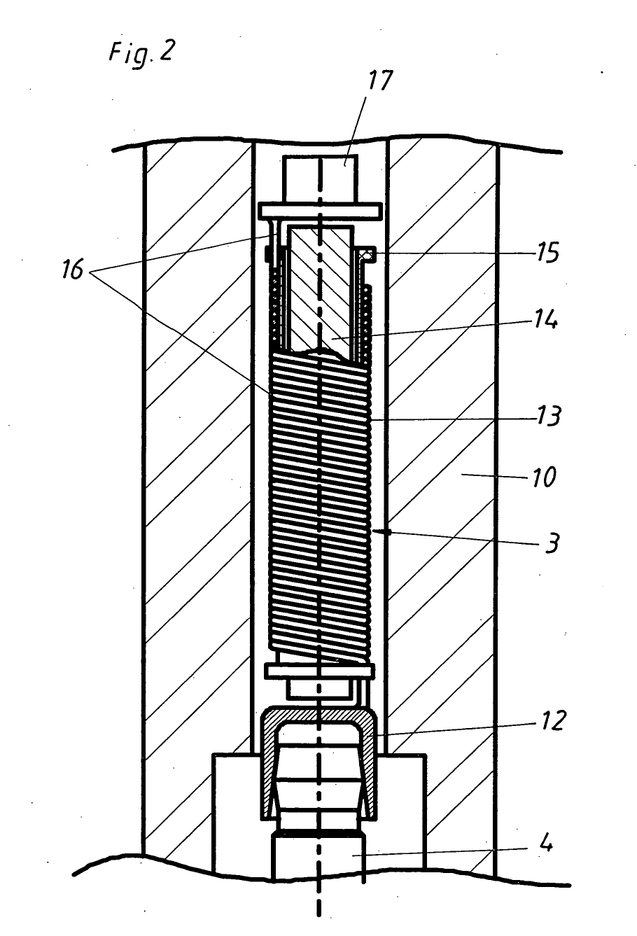

FIG. 2 shows a part region of the spark plug connector from FIG. 1, in the region of the inductive interference suppression device,

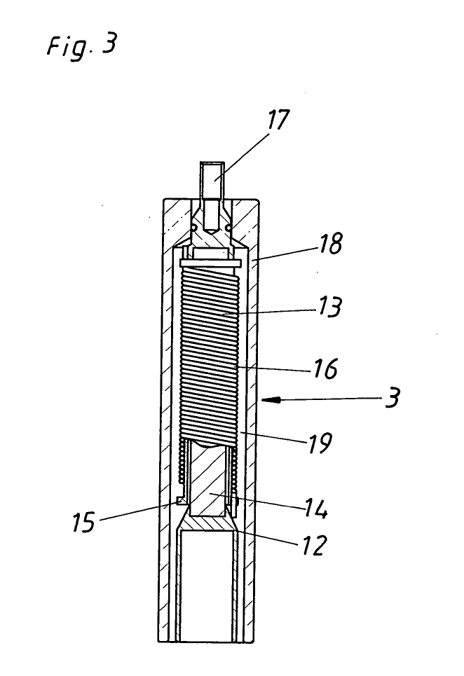

FIG. 3 shows a variant embodiment of the inductive interference suppression device, surrounded by a ceramic element, and

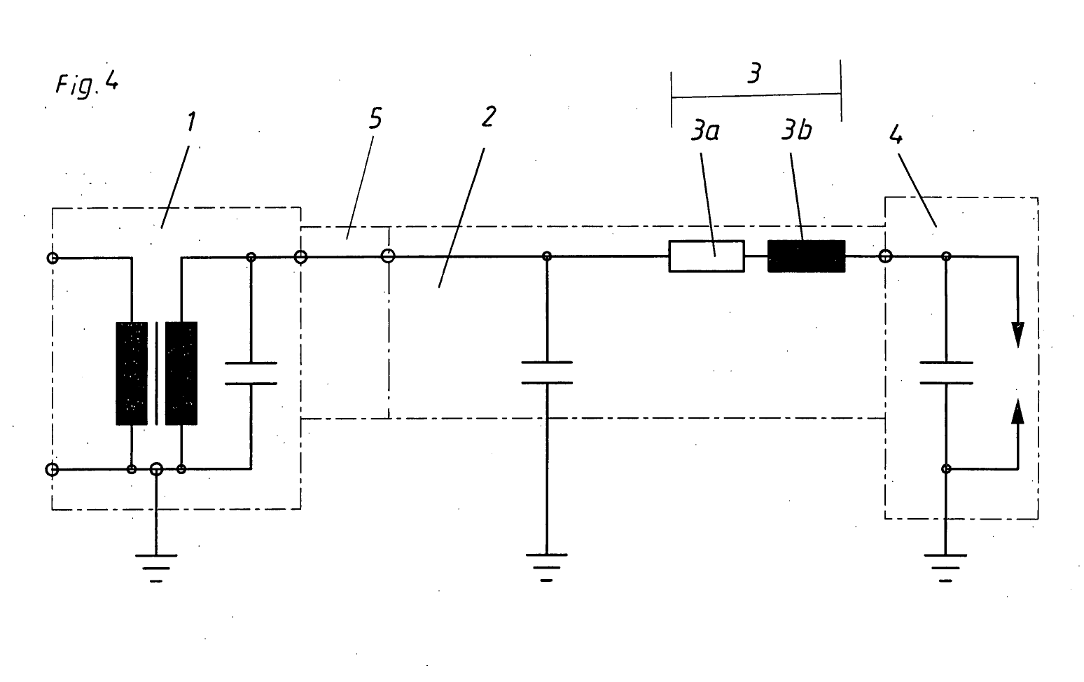

FIG. 4 shows an equivalent electrical circuit diagram.

FIG. 1 shows a structure, in accordance with the invention, in a diagrammatic sectional illustration. The ignition coil 1 is illustrated in highly simplified manner and may be constructed as known from the prior art. A spark plug lead 5 leads from the ignition coil 1 into the spark plug connector 2, which is arranged in a bore 6 in the engine block 7 and is pushed onto a spark plug 4. Conventionally, there is on the end of the spark plug connector 2 remote from the spark plug 4 a plug contact which serves to connect it to an external spark plug cable 5. This detail is not illustrated here, but may be constructed as known from the prior art. Preferably, the spark plug connector is a separate component from the ignition coil 1. As a result of this, unnecessary loads on the ignition coil arising from vibration and heat are avoided, since the ignition coil can be arranged at a remote location, connected to the spark plug connector 2 by way of the spark plug lead 5.

The spark plug connector 2 has a support 10 made from polytetrafluoroethylene, with a central bore 11. The spark plug lead 5 is guided inside the spark plug connector 10 through this bore to the inductive interference suppression device 3. As illustrated, the spark plug connector 2 is pushed onto the spark plug 4, as known from the prior art, making an electrical contact by way of the terminal contact 12. The support 10, substantially intrinsically rigid, of the spark plug connector makes it possible for pushing the spark plug connector onto the spark plug 4 to be sufficient to secure it. In addition, however, a fixing device 8 which secures the spark plug connector 10 to the engine block 7 may also be provided. For this purpose, screw, plug or other types of clamping connections may be provided. To obtain the maximum effect of the inductive interference suppression device 3 with the minimum of losses, the interference suppression device 3 should be mounted as close as possible to the main source of interference. In this case, the source of interference is spark-over at the electrodes of the spark plug 4. Because it is impossible in practice to arrange the inductive interference suppression device 3 in the spark plug, for mechanical and thermal reasons, taking into account too the overall size of the inductive interference element 3, the inductive interference suppression element 3 should be electrically connected as close as possible, preferably substantially directly, to the terminal contact 12. This is shown in FIGS. 2 and 3. The inductive interference suppression element 3 suppresses interference on the entire spark plug lead 5 on the side of the device 3 remote from the spark plug. This is particularly advantageous in the case of remotely arranged ignition coils, since otherwise the spark plug leads 5, which primarily in the case of large engines are very long, would act as antennae for the interference signals produced by the spark plug.

The inductive interference suppression device 3 should in principle be configured such that interference primarily in the frequency range between 1 MHz and 1 GHz, preferably between 30 MHz and one GHz, is suppressed particularly effectively. For this purpose, it is advantageous for the inductive interference suppression device to have an inductance of between 200 μH and 500 μH, preferably between 300 μH and 400 μH. The electric strength of the spark plug connector 2 overall should be more than 10 kV, preferably more than 30 kV. Together with the ohmic d.c. resistors of the inductive interference suppression device 3 that have already been indicated above, this makes it possible to transmit high levels of ignition power with very low losses and hence very low heat generation. In practice, levels of ignition power of more than 200 mJ to 1 J at an ignition rate, or a number of ignitions per unit of time, of 12.5 Hz to 15 Hz can be transmitted without problems. When resistor wire is used, the latter may preferably be made from a nickel chromium alloy. Examples of such alloys are sold under the trade name ISA-CHROM.

Advantageous variants on the spark plug connector provide for it to have a length of at least 10 cm, preferably between 40 cm and 70 cm. In relation to the position of the inductive interference suppression device 3, however, it may also be provided for the end of the spark plug connector 2 remote from the terminal contact 12 to be at least 10 cm, preferably between 40 cm and 70 cm, away from the end of the inductive interference suppression device 3 which is remote from the terminal contact 12.

FIG. 2 shows in detail the inductive interference suppression device 3 which was illustrated only diagrammatically in FIG. 1. Advantageously, it has a maximum length of 80 mm and a maximum diameter of 12 mm. In the example shown, a winding 13 made from resistor wire 16 is arranged around a ferromagnetic core 14, for example made from electrically non-conductive ferrite. In FIG. 2, the core and winding are shown in a sectional illustration in the upper region and in a side view in the lower region. Instead of the resistor wire 16, ordinary wire having a relatively low ohmic resistance can also be used if an additional ohmic resistor component is then connected in series with the winding 13. The winding 13 is wound onto an additional winding support 15 in the example embodiment shown. However, the latter may also be omitted from other example embodiments. In these cases, the winding 13 of the wire or the resistor wire is wound directly onto the core 14. The appropriate selection of the material of the core 14 and the insulation of the wire or resistor wire may, here too, have the result of achieving an electric strength in the spark plug connector of more than 10 kV, preferably more than 30 kV, preferably between both terminals 17 and 12. For this variant, high-resistance ferrite cores are particularly suitable. In all cases, it is advantageous if the core 14 is arranged on the inside of the winding 13. For the reasons stated above, it is preferable to arrange the terminal contact 12 for the spark plug 4 directly at the lower end of the winding 13. At the opposite end of the winding 13 there is provided a plug, clamping or screw device 17 which serves to make the contact with the spark plug lead 5. Here, connections which may be made by pushing the spark plug leads 5 into the bore 11 and which thereafter are preferably not detachable again are advantageous. Alternatively, however, it may also be provided for the spark plug lead 5 to be directly connected to the resistor wire 16, in which case the component 17 can be dispensed with. The inductive interference suppression element 3, like the spark plug lead 5, may be clamped inside the bore 11 of the support 10 or indeed encapsulated therein.

FIG. 3 shows a further variant on the interference suppression device 3. This has a ceramic element 18 which surrounds the ferromagnetic core 14, the winding 13 with the ohmic d.c. resistor, and in this example embodiment the terminal contact 12 as well. If the example embodiment according to FIG. 3 is integrated inside the spark plug connector, the support 10 in turn surrounds the ceramic element 18. The space between the winding 13 and the ceramic element 3 may be filled for example with an encapsulating polyester resin or the like.

FIG. 4 shows an equivalent electrical circuit diagram for the arrangement of the ignition coil 1, the spark plug connector 2 with inductive interference suppression device 3 and the spark plug 4. The ignition coil 1 and the spark plug connector 2, which is arranged separately therefrom, are electrically connected to one another by way of the spark plug lead 5. The inductive interference suppression device 3 includes both the inductance 3b and the ohmic d.c. resistor 3a. The ohmic d.c. resistance of 20 Ω at 20° C. may be created and/or supplemented by an additional resistor component 3a connected in series, as illustrated in FIG. 4. However, it is more advantageous if the d.c. resistance is provided, preferably in its entirety, by the use of resistor wire for the coil or winding 13.

1. A spark plug connector comprising: an inductive interference suppression device having a ferromagnetic core with at least one winding and an ohmic d.c. resistance of at least 20 Ω at 20° C.

2. The spark plug connector of claim 1, wherein the inductive interference suppression device has an ohmic d.c. resistance of at least 100 Ω at 20° C.

3. The spark plug connector of claim 1, wherein the inductive interference suppression device has an ohmic d.c. resistance of at least 500 Ω at 20° C.

4. The spark plug connector of claim 1, wherein the winding has a resistor wire to provide the ohmic d.c. resistance.

5. The spark plug connector of claim 1, wherein a resistor component is connected in series with the winding.

6. The spark plug connector of claim 1, wherein a resistor component is connected in series with the winding in the interference suppression device.

7. The spark plug connector of claim 1, further comprising a terminal contact for a spark plug, wherein the inductive interference suppression device is electrically connected as close as possible to the terminal contact.

8. The spark plug connector of claim 1, further comprising a terminal contact for a spark plug, wherein the inductive interference suppression device is electrically connected directly to the terminal contact.

9. The spark plug connector of claim 1, wherein the ferromagnetic core, the winding and the ohmic d.c. resistor are at least partly surrounded by a ceramic element.

10. The spark plug connector of claim 1, further comprising a terminal contact for a spark plug, wherein the inductive interference suppression device has at its end remote from the terminal contact a plug, clamping or screw connection device for making contact with a spark plug lead which is at least partly guided inside the spark plug connector.

11. The spark plug connector of claim 1, wherein the ferromagnetic core includes ferrite or is made substantially from ferrite.

12. The spark plug connector of claim 1, wherein the inductive interference suppression device has an inductance of between 200 μH and 500 μH.

13. The spark plug connector of claim 1, wherein the inductive interference suppression device has an inductance of between 300 μH and 400 μH.

14. The spark plug connector of claim 1, wherein the inductive interference suppression device is effective in the frequency range between 1 MHz and 1 GHz.

15. The spark plug connector of claim 1, wherein the inductive interference suppression device is effective in the frequency range between 30 MHz and 1 GHz.

16. The spark plug connector of claim 1, wherein the connector has an electric strength more than 10 kV.

17. The spark plug connector of claim 1, wherein the connector has an electric strength of more than 30 kV.

18. The spark plug connector of claim 1, wherein the connector has a length of at least 10 cm.

19. The spark plug connector of claim 1, wherein the connector has a length of between 40 cm and 70 cm.

20. The spark plug connector of claim 1, further comprising a terminal contact for a spark plug, wherein the end of the spark plug connector remote from the terminal contact is at least 10 cm away from the end of the inductive interference suppression device which is remote from the terminal contact.

21. The spark plug connector of claim 1, further comprising a terminal contact for a spark plug, wherein the end of the spark plug connector remote from the terminal contact is between 40 cm and 70 cm away from the end of the inductive interference suppression device which is remote from the terminal contact.

22. The spark plug connector of claim 1, wherein the connector is substantially a rigid component.

23. The spark plug connector of claim 22, wherein the connector has a support including polytetrafluoroethylene.

24. The spark plug connector of claim 1, wherein the connector is a separate component from an ignition coil.

25. The spark plug connector of claim 1, wherein the connector is adapted for large engines.

26. The spark plug connector of claim 1, wherein the winding has a coil.

27. The spark plug connector of claim 1, wherein the winding is wound directly onto the core.
